(19) United States
(12) Patent Application Publication
(10) Pub. No.: US 2005/0265262 A1
(43) Pub. Date: Dec. 1, 2005

(54) Data transmission device, data transmission system, and method

(76) Inventors: Yuji Mizuguchi, Hirakata (JP); Nobuhiko Yasui, Moriguchi (JP); Noboru Katta, Kawasaki (JP); Takahisa Sakai, Yokohama (JP); Yutaka Takahira, Neyagawa (JP); Hirotsugu Kawada, Osaka (JP); Toshitomo Umei, Settsu (JP); Takashi Akita, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/529,251

(22) PCT Filed: Dec. 24, 2003
(86) PCT No.: PCT/JP03/16522

§ 371 Date: Mar. 25, 2005

(30) Foreign Application Priority Data
Dec. 26, 2002 (JP) 2002-377318

(51) Int. Cl. H04L 12/28

(52) U.S. Cl. 370/258

(57) ABSTRACT

A data transmission device (1) includes a controller (2), a reception section (5), a transmission section (6), and an MPU (3). The reception section (5) receives an electric signal sent from a preceding device, and outputs its data to the controller (2). The transmission section (6) converts a result of a process by the controller (2) into an electric signal and transmits it to a successive device. The MPU (3) controls operation of the controller (2), the reception section (5), and the transmission section (6) in accordance with the operation mode of the device. The reception section (5) detects cessation of the electric signal sent from the preceding device and, in response to the detection, stops operating. In response to the detection, the transmission section (6) stops operating and stops sending the electric signal to the successive device.

### TECHNICAL FIELD

The present invention relates to a data transmission device, a data transmission system, and a method therefor, and more specifically to data transmission devices, a data transmission system, and a method therefor in which the data transmission devices are connected via a transmission line(s) so as to form a ring structure and in which they electrically communicate with one another in a single direction.

### BACKGROUND ART

In recent years, in car navigation or when doing the Internet, e.g., ITS (Intelligent Transport Systems), or transmitting image information in space such as the inside of a motor vehicle, high-volume and high-speed communication is required. A great deal of study is being made on communication systems for transmitting such digitized video or audio data, or digital data such as computer data or the like. Also, introduction of a network for transmitting digital data into even space such as the inside of a motor vehicle is becoming more and more widespread. For example, this intra-vehicle network uses a ring topology as its physical topology, and connects a plurality of nodes with the ring topology to form a unidirectional ring LAN, thus aiming to achieve integrated connection of an audio device, a navigation device, an information terminal device, or the like. For example, Media Oriented Systems Transport (hereinafter referred to as MOST) is used for the aforementioned ring LAN as an information communications protocol. The MOST refers to not only the communications protocol but also a method for constructing a distributed system. Data on a MOST network is transmitted with a frame being a basic unit, and frames are sequentially transmitted between the nodes in a single direction.

Noticeably, in the case of a ring LAN provided in the inside of a vehicle or the like, radiated noise may cause malfunction of another electronic device disposed on a motor vehicle or the like; besides, there is a necessity to perform accurate transmission without receiving any influence of radiated noise from another device. For this reason, a ring LAN using a conventional MOST presupposes that the communications protocol in the MOST is optical communication, and each node is connected by use of an optical-fiber cable, whereby protection from noise is improved while preventing generation of electromagnetic waves. Mean while, in a data transmission system disclosed in International Publication Pamphlet No. 02/30079, data communication is performed with electric signals using inexpensive cables such as twisted-pair cables or coaxial cables, while data transmission at high speed exceeding 20 Mbps is realized with a little radiated noise and improved protection from noise.

With reference to FIG. 7, a data transmission system using a ring network in which each node is connected with an inexpensive cable such as a twisted-pair cable or a coaxial cable is described. FIG. 7 is a block diagram showing a configuration of the ring network.

In FIG. 7, the ring network is composed of n data transmission devices 100a to 100n in which each node performs data transmission and reception. To the data transmission devices are connected connected-devices 110a to 110n each performing a process based on data transmitted by the data transmission device and outputting its resultant to the data transmission device. Note that as a common hardware configuration, the data transmission devices 100a to 100n and the connected-devices 110a to 110n respectively have integral structures. The data transmission devices 100a to 100n are connected via transmission lines 130a to 130n composed of coaxial cables or twisted-pair cables so as to form a ring structure. Each of the data transmission devices 100a to 100n has the same structure, having a processing section for processing the communications protocol of the ring network, a transmission section, and a reception section (which are not shown). For example, the transmission section provided in the data transmission device 100a outputs data to the reception section provided in the data transmission device 100b via the transmission line 130a; and the reception section provided in the data transmission device 100a receives data from the transmission section provided in the data transmission device 100n via the transmission line 130n.

A data transmission method in which the devices 100a to 100n conduct output to the transmission lines 130a to 130n is described. A digital data sequence from the connected-device or the like connected to each one of the data transmission devices 100a to 100n is divided by the respective transmission section into units of a predetermined number of bits to obtain data symbols, which are converted through mapping by use of a conversion table and a filtering process into an analog signal, which in turn is outputted to a corresponding one of the transmission lines 130a to 130n. The analog signal is outputted as a waveform in which mapped signal levels are in a predetermined cycle. Then, the reception section of each of the data transmission devices 100a to 100n receives the analog signal, which is decoded through a filtering process and inverse mapping into data symbols, which in turn are converted into a digital data sequence.

Here, in the case of an intra-vehicle network, while the network is not used, it is required that a mode (hereinafter referred to as a “zero-power mode”) be available in which operation is suspended by turning off main hardware constituting the network in order to reduce power consumption to the least possible. In the case where transmission/reception involves conversion into an analog signal as described above, turning off the transmission section and the reception section makes it difficult for all data transmission devices to return from the zero-power mode in coordination with one another.

Another conceivable method is to allow the powers of the transmission section and reception section of the data transmission device to remain turned on while shifting the processing section and the connected-device to the zero-power mode. In this case, however, power consumption of the entire network is large in the zero-power mode. For example, consider the case where the ring network is provided inside a motor vehicle and operation of the entire network is to be suspended by shifting the ring network to the zero-power mode when the key of the motor vehicle is turned off. In this case, it is necessary to make power consumption as little as possible (to make it nearly zero) because while the key of the motor vehicle is off, there is no electric power generation by an engine, resulting in limited power capacity. In the zero-power mode as described above where the powers of the transmission section and reception section of the data transmission device remain turned on, it is difficult to restrict power consumption to zero. In other words, the zero-power mode where the powers of only the processing section of the data transmission device and the connected-device are turned off does not achieve an essential object of the zero-power mode.

Therefore, an object of the present invention is to provide a data transmission device, a data transmission system, and a method therefor, which, in a mode involving turning off main hardware constituting a ring network, allows power consumption in that mode to be low and in which it is easy to return to a normal operation mode.

### DISCLOSURE OF THE INVENTION

The present invention has the following features to attain the object above.

A data transmission device according to the present invention is connected to a ring-type data transmission network, and electrically communicates with another device via a transmission line in a unidirectional manner. The data transmission device includes: a processing section for processing received data and data to be transmitted based on a predetermined communications protocol; a reception section for receiving an electric signal sent from a preceding device and outputting data contained in the electric signal to the processing section; a transmission section for converting a result of a process by the processing section into an electric signal and transmitting the electric signal to a successive device; and a control section for controlling operation of the processing section, the reception section, and the transmission section in accordance with an operation mode of its own device. The reception section detects cessation of the electric signal sent from the preceding device and, in response to the detection, stops operating. In response to the detection, the transmission section stops operating and stops sending the electric signal to the successive device.

According to the above-described structure of the present invention, in a zero-power mode that stops operation of main hardware, the operation of the reception section and the transmission section included in the data transmission device is stopped; therefore power consumption of each of them is reduced, whereby power consumption of the entire device is greatly reduced. In addition, the data transmission device detects the cessation of the electric signal sent from the preceding data transmission device, then shifts itself to the zero-power mode, and stops sending the electric signal to the successive data transmission device; therefore, the data transmission devices connected to the ring-type data transmission network are able to shift to the zero-power mode in combination.

As a first example, if the cessation of the electric signal sent from the preceding device is detected, the reception section transmits, to the control section, a data cessation signal for indicating the cessation; and based on the data cessation signal transmitted from the reception section, the control section stops operation of the processing section. As a second example, if the cessation of the electric signal sent from the preceding device is detected, the reception section transmits, to the control section, a data cessation signal for indicating the cessation; based on the data cessation signal transmitted from the reception section, the control section outputs a signal for stopping operation of the reception section and the transmission section; in response to the signal outputted from the control section in response to the detection, the reception section stops operating; and in response to the signal outputted from the control section in response to the detection, the transmission section stops operating and stops sending the electric signal to the successive device. As a third example, a power supply section for supplying power to the processing section, the reception section, and the transmission section is further included; if the cessation of the electric signal sent from the preceding device is detected, the reception section transmits, to the control section, a data cessation signal for indicating the cessation; and based on the data cessation signal transmitted from the reception section, the control section stops the power supply section from supplying power to the processing section, the reception section, and the transmission section. By these examples, in the zero-power mode, the operation of the processing section included in the data transmission device is stopped, or power supply to the transmission section and the reception section is stopped. Therefore, power consumption is further reduced, and even in the case where the reception section and the transmission section do not have functions for turning off the power by themselves, their operation can be stopped and moreover, power consumption of each of them can be completely restricted to zero.

Further, there may be included a signal monitoring section for detecting the electric signal sent from the preceding device and transmitting, to the control section, an electric-signal detection signal for indicating the detection. In this case, if suspended sending of the electric signal sent from the preceding device is resumed, the signal monitoring section detects the electric signal sent from the preceding device, and transmits, to the control section, the electric-signal detection signal for indicating the detection; based on the electric-signal detection signal transmitted from the signal monitoring section, the control section starts operation of the processing section, the reception section, and the transmission section; and by control of the control section, the transmission section starts operating and starts sending the electric signal to the successive device. Because of this, once the sending of the electric signal from the preceding data transmission device is resumed, the data transmission device which has shifted to the zero-power mode detects the electric signal with the signal monitoring section, and starts operation of the processing section, the reception section, and the transmission section, thereby returning to a normal operation mode. Therefore, the data transmission device is capable of allowing the processing section, the reception section, and the transmission section, which had stopped their operation, to easily start their operation, there by returning to the normal operation mode. In addition, after returning to the normal operation mode, the data transmission device resumes sending the electric signal to the successive data transmission device. Therefore, the data transmission devices connected to the ring-type data transmission network are able to return to the normal operation mode in combination.

For example, the electric signal which the transmission section sends to the successive device after starting operating by control of the control section is a lock signal for establishing clock synchronization. Because of this, since the electric signal for allowing the data transmission device to return to the normal operation mode is a lock signal for establishing clock synchronization, it is possible to simultaneously perform a clock reproduction process together with the return process. In addition, for example, the communications protocol used by the processing section is defined by Media Oriented Systems Transport (MOST). Because of this, in the case where the data transmission devices connected to the ring-type data transmission network perform data communication with an electric signal using the MOST as the communications protocol, the operation of the reception section and the transmission section included in the data transmission device is stopped in the zero-power mode; therefore, power consumption of each of them is reduced, whereby power consumption of the entire device is greatly reduced. Moreover, the data transmission device detects the cessation of the electric signal sent from the preceding data transmission device, shifts itself to the zero-power mode, and stops the electric signal sent to the successive data transmission device; therefore, the data transmission devices connected to the ring-type data transmission network are able to shift to the zero-power mode in combination.

A data transmission system according to the present invention includes a plurality of data transmission devices connected via a transmission line so as to form a ring structure, in which the data transmission devices electrically communicate with one another in a unidirectional manner. The data transmission devices each include: a processing section for processing received data and data to be transmitted based on a predetermined communications protocol; a reception section for receiving an electric signal sent from a preceding data transmission device and outputting data contained in the electric signal to the processing section; a transmission section for converting a result of a process by the processing section into an electric signal and transmitting the electric signal to a successive data transmission device; and a control section for controlling operation of the processing section, the reception section, and the transmission section in accordance with an operation mode of its own device, wherein, in at least one of the data transmission devices, the control section stops operation of the processing section, the reception section, and the transmission section of its own device based on a predetermined condition for shift, and the transmission section stops transmission of the electric signal, and in another data transmission device, the reception section of its own device detects cessation of the electric signal sent from a preceding data transmission device and, in response to the detection, stops operating; and the transmission section of its own device stops operating in response to the detection and stops sending the electric signal to a successive data transmission device.

According to the above-described structure of the present invention, in the zero-power mode which stops operation of main hardware included in the data transmission device, the operation of the reception section and the transmission section is stopped; therefore, power consumption of each of them is reduced, and power consumption of the entire data transmission system is greatly reduced. In addition, at least one of the data transmission devices shifts to the zero-power mode based on the predetermined condition for shift and thereafter stops sending of the electric signal from itself; and another data transmission device detects the cessation of the electric signal sent from the preceding data transmission device, shifts itself to the zero-power mode, and stops sending the electric signal to the successive data transmission device. Therefore, the data transmission devices connected to the data transmission system are able to shift to the zero-power mode in combination.

As a first example, in the other data transmission device, if the cessation of the electric signal sent from the preceding data transmission device is detected, the reception section transmits, to the control section of its own device, a data cessation signal for indicating the cessation; and based on the data cessation signal transmitted from the reception section of its own device, the control section stops operation of the processing section of its own device. As a second example, in the other data transmission device, if the cessation of the electric signal sent from the preceding data transmission device is detected, the reception section transmits, to the control section of its own device, a data cessation signal for indicating the cessation; based on the data cessation signal transmitted from the reception section of its own device, the control section outputs a signal for stopping operation of the reception section and the transmission section of its own device; in response to the signal outputted from the control section of its own device in response to the detection, the reception section stops operating; and in response to the signal outputted from the control section of its own device in response to the detection, the transmission section stops operating and stops sending the electric signal to the successive data transmission device. As a third example, the data transmission devices each further include a power supply section for supplying power to the processing section, the reception section, and the transmission section of its own device; if the cessation of the electric signal sent from the preceding data transmission device is detected, the reception section transmits, to the control section of its own device, a data cessation signal for indicating the cessation; and based on the data cessation signal transmitted from the reception section of its own device, the control section stops the power supply section of its own device from supplying power to the processing section, the reception section, and the transmission section.

In addition, the data transmission devices may each further include a signal monitoring section for detecting the electric signal sent from the preceding data transmission device and transmitting, to the control section, an electric-signal detection signal for indicating the detection. In this case, in at least one of the data transmission devices, based on a predetermined return condition, the control section starts operation of the processing section, the reception section, and the transmission section of its own device in stopped state, and the transmission section resumes the transmission of the electric signal, and in another data transmission device, if suspended sending of the electric signal sent from the preceding data transmission device is resumed, the signal monitoring section detects the electric signal sent from the preceding data transmission device, and transmits, to the control section of its own device, the electric-signal detection signal for indicating the detection; based on the electric-signal detection signal transmitted from the signal monitoring section, the control section starts operation of the processing section, the reception section, and the transmission section of its own device; and the transmission section starts operating and starts sending the electric signal to the successive data transmission device. Because of this, in the data transmission system which has shifted to the zero-power mode, at least one of the data transmission devices returns to a normal operation mode based on the predetermined return condition and thereafter resumes the sending of the electric signal from itself; and once the sending of the electric signal from the preceding data transmission device is resumed, another data transmission device detects the electric signal with the signal monitoring section, and starts operation of the processing section, the reception section, and the transmission section, thereby returning to the normal operation mode. Therefore, the data transmission device is capable of allowing the processing section, the reception section, and the transmission section, which had stopped their operation, to easily start their operation, thereby returning to the normal operation mode. In addition, after returning to the normal operation mode, each data transmission device resumes sending the electric signal to the successive data transmission device. Therefore, the data transmission devices connected to the data transmission network are able to return to the normal operation mode in combination.

For example, the electric signal which each transmission section sends to the successive data transmission device after starting operating by control of the control section is a lock signal for establishing clock synchronization with each other. In addition, the data transmission device which resumes the transmission of the electric signal based on the predetermined return condition is, for example, a master, which performs data transmission with a clock held by itself and is connected to the data transmission system. Further, the communications protocol used by the processing section is defined by MOST, for example.

In a data transmission method according to the present invention, a plurality of nodes are connected via a transmission line so as to form a ring structure, and each node electrically communicates with one another in a unidirectional manner. The data transmission method includes: a processing step, performed by each node, of processing received data and data to be transmitted based on a predetermined communications protocol; a reception step, performed by each node, of receiving an electric signal sent from a preceding node and sending data contained in the electric signal to the processing step; a transmission step, performed by each node, of transmitting a result of a process by the processing step to a successive node as an electric signal; and a control step, performed by each node, of controlling operation of the processing step, the reception step, and the transmission step in accordance with an operation mode, wherein, in at least one of the nodes, the control step stops operation by the processing step, the reception step, and the transmission step of the node based on a predetermined condition for shift, and the transmission step stops transmission of the electric signal, and in another node, the reception step detects cessation of the electric signal sent from a preceding node and, in response to the detection, stops operation; and the transmission step of its own node stops operation in response to the detection and stops sending the electric signal to a successive node.

According to the above-described structure of the present invention, in the zero-power mode which stops operation of main hardware included in each node, operation by the reception step and the transmission step is stopped; therefore, power consumption required for their operation is reduced, and power consumption of each entire node connected so as to form a ring structure is greatly reduced. In addition, at least one of the nodes shifts to the zero-power mode based on the predetermined condition for shift and thereafter stops the sending of the electric signal from itself; and another node detects the cessation of the electric signal sent from the preceding node, shifts itself to the zero-power mode, and stops sending the electric signal to the successive node. Therefore, each node connected so as to form a ring structure is able to shift to the zero-power mode in combination.

As a first example, in the other node, if the cessation of the electric signal sent from the preceding node is detected, the reception step sends, to the control step of its own node, a notification indicating the cessation, and based on the notification sent by the reception step of its own node, the control step stops operation by the processing step of its own node. As a second example, in the other node, if the cessation of the electric signal sent from the preceding node is detected, the reception step sends, to the control step of its own node, a notification indicating the cessation; based on the notification sent by the reception step of its own node, the control step sends a notification for stopping operation by the reception step and the transmission step of its own node; in response to the notification sent by the control step of its own node in response to the detection, the reception step stops operation, and in response to the notification sent by the control step of its own node in response to the detection, the transmission step stops operation and stops sending the electric signal to the successive node. As a third example, the nodes each further include a power supply step of supplying power used for operation in the processing step, the reception step, and the transmission step; if the cessation of the electric signal sent from the preceding node is detected, the reception step sends, to the control step of its own node, a notification indicating the cessation; and based on the notification sent by the reception step of its own node, the control step stops the power supply step of its own node from supplying power used for operation of the processing step, the reception step, and the transmission step.

In addition, the nodes may each further include a signal monitoring step of detecting the electric signal sent from the preceding node and sending, to the control step, a notification indicating the detection. In this case, in at least one of the nodes, based on a predetermined return condition, the control step starts operation by the processing step, the reception step, and the transmission step of its own node in stopped state, and the transmission step resumes the transmission of the electric signal, and in another node, if suspended sending of the electric signal sent from the preceding node is resumed, the signal monitoring step detects the electric signal sent from the preceding node, and sends, to the control step of its own node, the notification indicating the detection; based on the notification indicating the detection sent by the signal monitoring step, the control step starts operation by the processing step, the reception step, and the transmission step of its own node; and operation by the transmission step is started to start the sending of the electric signal to the successive node. Because of this, regarding the nodes which have shifted to the zero-power mode, at least one of the nodes returns to the normal operation mode based on the predetermined return condition and thereafter resumes the sending of the electric signal by itself; and once the sending of the electric signal from the preceding node is resumed, another node detects the electric signal with the signal monitoring step and starts operation by the processing step, the reception step, and the transmission step, thereby returning to the normal operation mode. Therefore, the node is capable of allowing the processing step, the reception step, and the transmission step, which had stopped their operation, to easily start their operation, there by returning to the normal operation mode. In addition, after returning to the normal operation mode, each node resumes sending the electric signal to the successive node. Therefore, the nodes connected so as to form a ring structure are able to return to the normal operation mode in combination.

For example, the electric signal which each transmission step sends to the successive node after starting operation by control of the control step is a lock signal for establishing clock synchronization with each other. The node which resumes the transmission of the electric signal based on the predetermined return condition may be a master, which performs data transmission with a clock held by itself. In addition, the communications protocol used by the processing step is defined by MOST, for example.

### BRIEF DESCRIPTION OF THE DRAWINGS

FIG. 1 is a block diagram showing a configuration of a data transmission system according to an embodiment of the present invention.

FIG. 2 is a functional block diagram showing a structure of a data transmission device 1 in FIG. 1.

FIG. 3 is a flowchart showing an operation of the data transmission system of FIG. 1 for shifting from a normal operation mode to a zero-power mode.

FIG. 4 is a flowchart showing an operation of the data transmission system of FIG. 1 for returning from the zero-power mode to the normal operation mode.

FIG. 5 is a flowchart showing another exemplary operation of the data transmission system of FIG. 1 for shifting from the normal operation mode to the zero-power mode.

FIG. 6 is a flowchart showing another exemplary operation of the data transmission system of FIG. 1 for returning from the zero-power mode to the normal operation mode.

FIG. 7 is a block diagram showing a configuration of a conventional ring network.

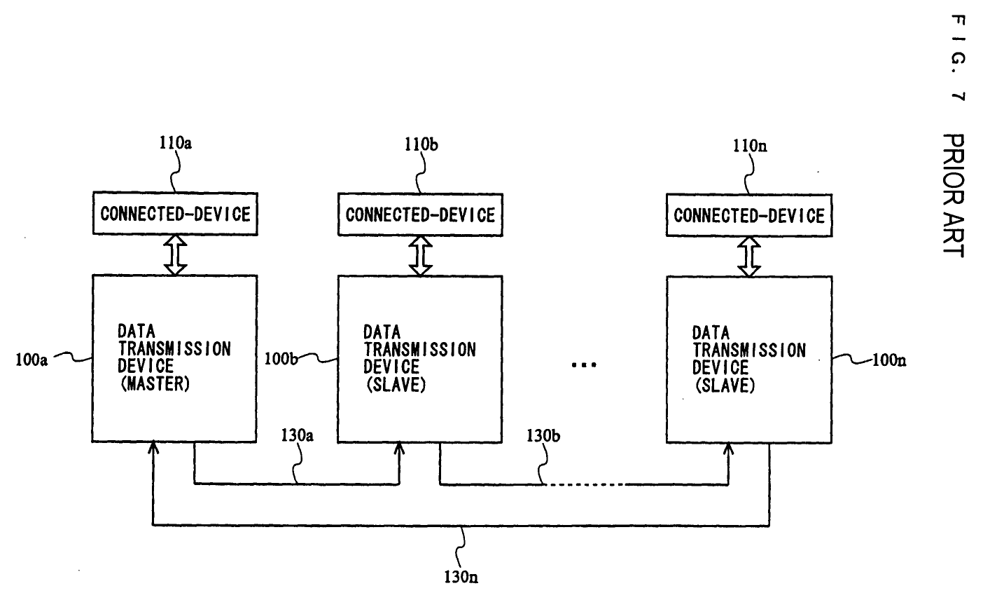

### BEST MODE FOR CARRYING OUT THE INVENTION

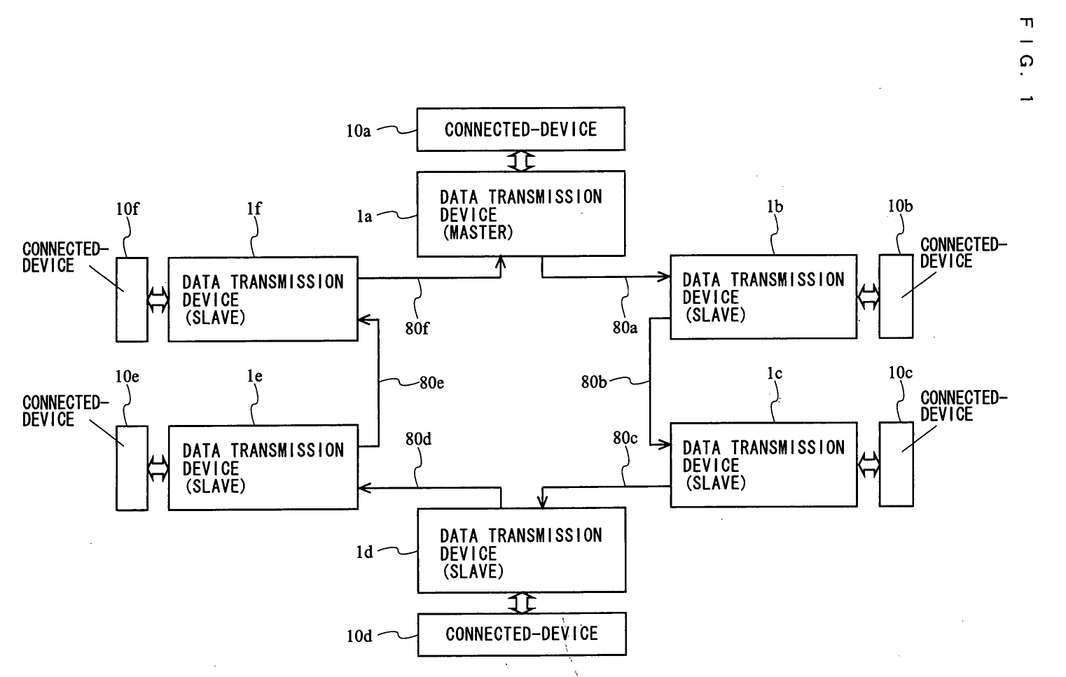

With reference to FIG. 1, a data transmission system according to an embodiment of the present invention is described. FIG. 1 is a block diagram showing a configuration of the data transmission system.

In FIG. 1, the data transmission system has a ring topology as its physical topology in which a plurality of nodes are connected according to the ring topology, thereby forming a unidirectional ring LAN. An example of such a data transmission system is described below where the nodes are composed of six data transmission devices 1a to 1f, which are connected via transmission lines 80a to 80f so as to form a ring structure, and transmitted data is transmitted via the transmission lines 80a to 80f in a single direction. To the data transmission devices 1a to 1f are connected connected-devices (e.g., audio devices, navigation devices, or information terminal devices) 10a to 10f each conducting a process based on data transmitted through the data transmission system and outputting its resultant to the data transmission system. Note that as a common hardware configuration, the data transmission devices 1a to 1f and the connected-devices 10a to 10f respectively have integral structures.

For example, Media Oriented Systems Transport (hereinafter referred to as MOST) is used as an information communications protocol for the above-described data transmission system. Data transmitted using the MOST as the communications protocol is transmitted with a frame being a basic unit, and frames are sequentially transmitted between the data transmission devices 1 in a single direction. In other words, the data transmission device 1a outputs data to the data transmission device 1b via the transmission line 80a. The data transmission device 1b outputs the data to the data transmission device 1c via the transmission line 80b. The data transmission device 1c outputs the data to the data transmission device 1d via the transmission line 80c. The data transmission device 1d outputs the data to the data transmission device 1e via the transmission line 80d. The data transmission device 1e outputs the data to the data transmission device 1f via the transmission line 80e. The data transmission device 1f outputs the data to the data transmission device 1a via the transmission line 80f. Inexpensive cables such as twisted-pair cables or coaxial cables are used as the transmission lines 80a to 80f,and the data transmission devices 1 mutually perform data communication with an electric signal. Here, in the data transmission system, the data transmission device 1a is a master, which transmits data with a clock of its own, and the other data transmission devices 1b to 1f are slaves, which operate synchronized with a clock generated at the master.

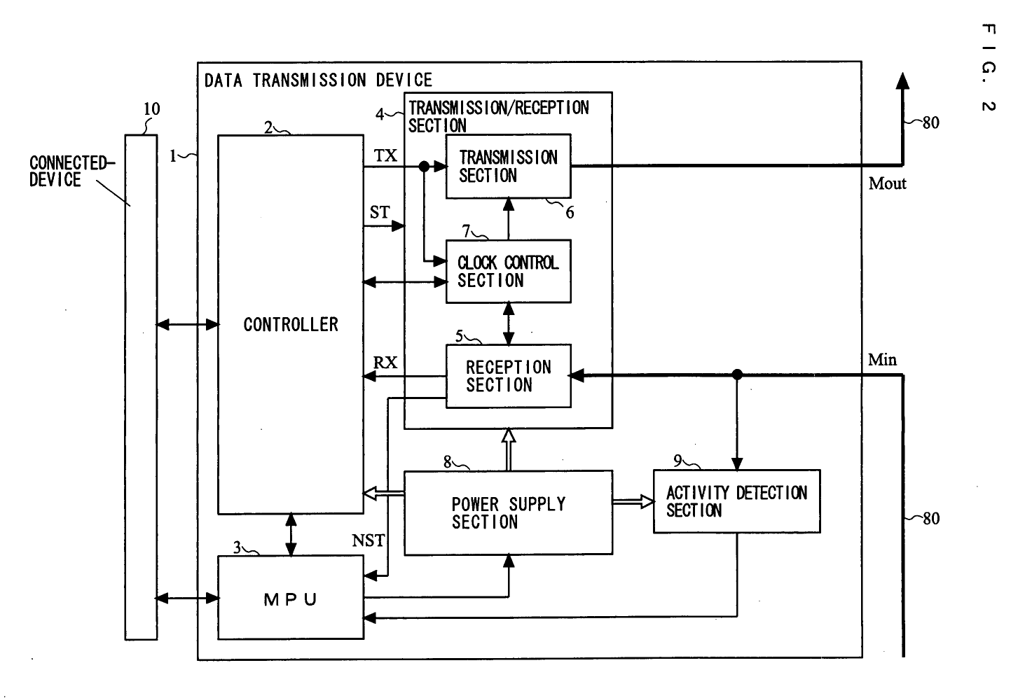

Next, with reference to FIG. 2, a structure of the data transmission device 1 is described. FIG. 2 is a functional block diagram showing the structure of the data transmission device 1. Note that the above-described plurality of data transmission devices 1a to 1f each have the same structure.

In FIG. 1, the data transmission devices 1 each includes a controller 2, a microcomputer (MPU) 3, a transmission/reception section 4, a power supply section 8, and an activity detection section 9. For example, the controller 2 is composed of an LSI and, in the case where the communications protocol used in the data transmission system is the MOST, performs a predetermined data transmission/reception process of the MOST. The description below is made using the MOST as an exemplary communications protocol used in the data transmission system.

To the controller 2 is connected the connected-device 10 which performs a process based on data transmitted in the data transmission system and outputs its resultant to the data transmission system. As its function, the controller 2 converts data from the connected-device 10 connected thereto into a protocol stipulated by the MOST, then outputting digital data TX to the transmission/reception section 4, and processes digital data RX outputted from the transmission/reception section 4, then transmitting it to the connected-device 10 connected thereto. In addition, the controller 2 outputs, to the transmission/reception section 4, an operation mode signal ST indicating a current operation mode.

The MPU 3 controls the controller 2, the transmission/reception section 4, and the aforementioned connected-device 10 based on a transmission mode of the data transmission device 1. For example, the MPU 3 controls the data transmission device 1 with respect to a reset function, a power control (a zero-power mode control, described below, on the controller 2 and the transmission/reception section 4), a master/slave selection process, a process of shifting to a diag mode, a scramble transmission function, etc.

A clock control section 7 controls a clock of the data transmission device 1: for example, it reproduces a clock generated at another data transmission device 1, reproduces a clock for the controller 2, and outputs a clock used in a transmission section 6.

The transmission/reception section 4, typically composed of an LSI, includes a reception section 5, the transmission section 6, and the clock control section 7. The reception section 5 receives an electric signal Min inputted from a preceding data transmission device 1 via the transmission line 80, and, based on a clock reproduced at the clock control section 7, converts the electric signal Min into a digital signal RX, and then outputs it to the controller 2. In addition, the reception section 5 reproduces a clock component included in the electric signal Min and outputs it to the clock control section 7. In addition, the reception section 5 outputs a reception operation mode signal NST to the MPU 3 based on the presence or absence of input of the electric signal Min from the preceding data transmission device 1 via the transmission line 80. Based on the clock of the clock control section 7, the transmission section 6 converts the digital data TX outputted from the controller 2 into an electric signal Mout, then outputting it to a successive data transmission device 1 via the transmission line 80.

A function of the transmission section 6 is described in detail. The transmission section 6 has inside it an S/P (serial/parallel) conversion section, a mapping section, a roll off filter, a DAC (a digital to analog converter), a differential driver, a training signal generation section, and the like. For example, by their operation, the transmission section 6 converts the digital data TX into an analog electric signal Mout subjected to eight-value mapping, then outputting it. The function of the transmission section 6 is described below with reference to an exemplary case where conversion is made into an analog signal Mout subjected to eight-value mapping.

First, based on a clock controlled by the clock control section 7, the transmission section 6 selects data (e.g., digital data TX) to be transmitted to the transmission line 80 and performs an S/P conversion process. This S/P conversion process converts serial digital data TX outputted from the controller 2 into parallel form in order to perform multilevel transmission. In the case where the communications protocol is the MOST, since the output from the controller 2 is made in the form of serial digital data TX, the S/P conversion process converts serially inputted data into two-bit parallel data. Regarding the clock, by the clock control section 7, used by the transmission section 6: in the case where the data transmission device 1 is the master, a clock reproduced by a transmission-side PLL (Phase Locked Loop) based on a clock held by itself is used; whereas in the case where it is a slave, a clock component of a signal received from the transmission line 80 is extracted, and a clock reproduced by a reception-side PLL is used as a system clock. The transmission-side PLL and the reception-side PLL are both contained in the clock control section 7.

Next, the transmission section 6 maps the two-bit parallel data subjected to the S/P conversion and a training signal TS outputted from the training signal generation section onto one of eight values of symbols based on the aforementioned system clock. In this mapping, in order that another data transmission device 1 disposed on the receiving side may perform clock reproduction, the two-bit parallel data is allocated alternately to upper four values of symbols and lower four values of symbols among the eight values of symbols. In addition, in order to exclude influence of fluctuation or difference of direct-current components between transmission and reception, the mapping is performed based on difference from a previous value. Moreover, regarding the signal after mapping, the transmission section 6 limits the bandwidth of the electric signal which is to be transmitted and controls intersymbol interference by using a roll off filter. For this roll off filter, which is, for example, a wave-shaping filter, a 33-tap, 12-bit FIR filter characterized by performing route distribution on a roll-off rate of 100% with a sampling frequency four times a symbol rate is used, for example.

Next, by using the DAC, the transmission section 6 converts into an analog signal the signal whose bandwidth has been limited by the roll off filter. Then, using the differential driver, the transmission section 6 amplifies the intensity of the analog signal outputted from the DAC and converts it into a differential signal, then sending it to the transmission line 80. For a pair of lead wires included in the transmission line 80, the differential driver transmits the electric signal, which is sent, to one side (a positive side) of the lead wires in the transmission line 80, while transmitting a signal whose positive and negative are inverse to those of the electric signal to the other side (a negative side) in the transmission line 80. Thus, the electric signals of the positive side and the negative side are sent, as a pair, to the transmission line 80, whereby influence of noise radiated from the transmission line 80 and common mode noise introduced from outside can be reduced.

The training signal generation section in the transmission section 6 generates a predetermined training signal TS for setting determination levels, which serve as a criterion for data determination made in association with the other data transmission device 1 disposed on the receiving side. Similarly to the above-described digital data TX, the training signal TS generated by the training signal generation section is subjected to mapping, analog conversion, and the like, and then sent to the transmission line 80.

Next, a function of the reception section 5 is described in detail. The reception section 5 has a differential receiver, an ADC (analog to digital converter), a roll off filter, a inverse mapping section, a P/S (Parallel/Serial) conversion section, a clock reproduction section, and the like.

First, by using the differential receiver, the reception section 5 converts an electric signal Min inputted from the transmission line 80 into a voltage signal. As described above, transmission is performed with a differential signal, which is composed of the positive side and the negative side paired for the pair of lead wires contained in the transmission line 80. The differential receiver, which determines a signal based on difference between the positive side and the negative side, works effectively against influence of common mode noise introduced from outside. Then, by using the ADC, the reception section 5 converts into a digital signal the voltage signal obtained by the conversion by the differential receiver.

Next, by using the roll off filter, the reception section 5 performs noise reduction on the digital signal obtained by the conversion by the ADC. For this roll off filter, which is also an FIR filter for waveform shaping, an FIR filter with sixteen times a symbol rate is used, for example. It realizes a roll-off characteristic without intersymbol interference in conjunction with the above-described roll off filter of the transmission section 6. Then, by using the inverse mapping section and based on a clock reproduced by the clock reproduction section, the reception section 5 reproduces data before being subjected to mapping by the mapping section on the transmitting side based on difference between a received data value and a previous value. A process at the inverse mapping section is performed, using as a criterion the determination levels set by the training signal TS as described above, and the determination levels are used as ideal values in difference. By this inverse mapping process, a received signal is converted into parallel data. Then, the reception section 5 performs a P/S conversion process on the parallel data obtained after the inverse mapping process to obtain serial digital data RX and outputs it to the controller 2.

The clock reproduction section in the reception section 5 detects the clock component of the signal received from the transmission line 80, which is outputted from the ADC, thereby reproducing a transmission line clock. The clock reproduced by the clock reproduction section is outputted to the clock control section 7 to be used as a reference clock for the reception-side PLL.

Based on power control by the MPU 3, the power supply section 8 supplies power to the controller 2, the transmission/reception section 4, the activity detection section 9, etc. The activity detection section 9, which is typically composed of an electric circuit having a comparator, etc., monitors the electric signal Min from the transmission line 80, which is inputted to the data transmission device. In addition, if an electric signal Min is detected in a zero-power mode described below, the activity detection section 9 reports the detection to the MPU 3.

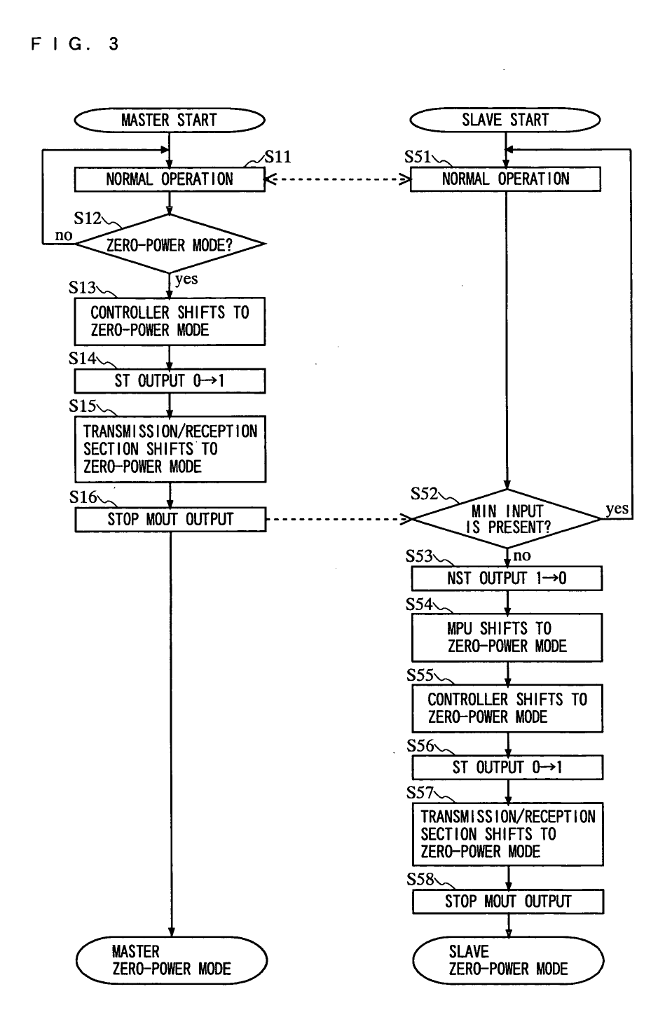

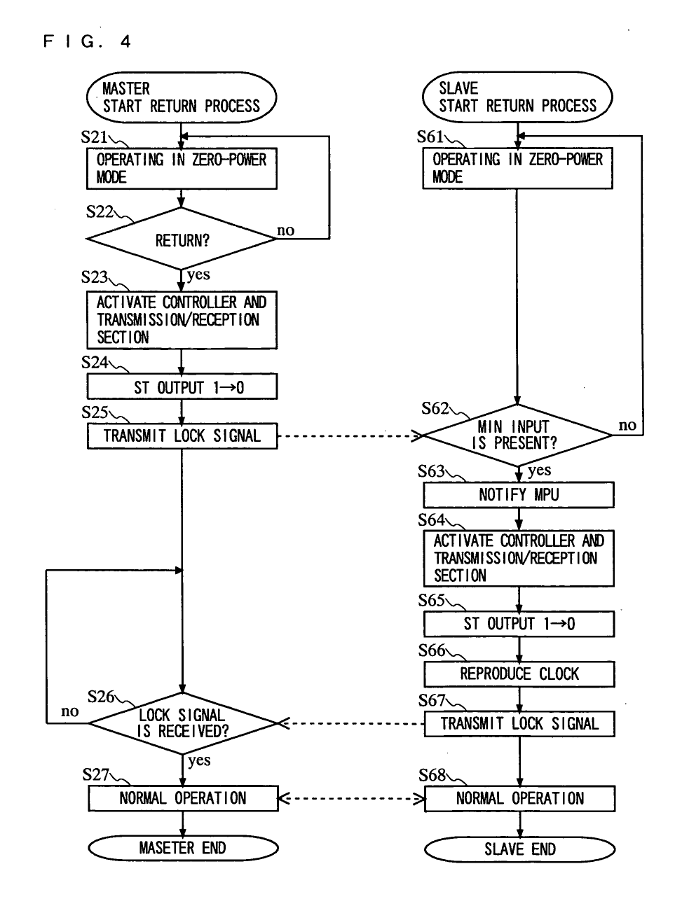

In the case of a data transmission system inside a vehicle, power capacity available for the data transmission system is limited, for example; therefore, while a network is not used, it is necessary to shift to a mode (zero-power mode) in which operation is suspended while main hardware constituting the network is turned off to consume as little power as possible. With reference to FIGS. 3 and 4, a process, in the data transmission system, of shifting from a normal operation mode to the zero-power mode and thereafter returning from the zero-power mode to the normal operation mode is described below. FIG. 3 is a flowchart showing an operation of the data transmission system for shifting from the normal operation mode to the zero-power mode, and FIG. 4 is a flowchart showing an operation of the data transmission system for returning from the zero-power mode to the normal operation mode.

First, with reference to FIG. 3, the operation of the data transmission system for shifting from the normal operation mode to the zero-power mode is described. The shifting operation of the data transmission device described below is applicable to any system in which a plurality of data transmission devices 1 are connected so as to form a ring structure. However, for making a specific explanation, the description is made with reference to an exemplary case where six data transmission devices 1a to 1f are connected via transmission lines 80a to 80f so as to form a ring structure (see FIG. 1). Note that as described above, in the data transmission system, the data transmission device 1a is the master which transmits data with the clock of its own, while the other data transmission devices 1b to 1f are slaves which operate synchronized with a clock generated at the master.

In FIG. 3, all data transmission devices 1a to 1f connected to the data transmission system are in the normal operation, exchanging data between one another (steps S11 and S51). The master data transmission device 1a determines, during the normal operation, whether or not to shift to the zero-power mode (step S12), and, if the shift to the zero-power mode is not conducted, continues the above step S11.

The determination instep S12 as to the shift to the zero-power mode is typically performed by the MPU 3 included in the master data transmission device 1a.For example, in the case where the data transmission system is provided inside a motor vehicle, the MPU 3 performs the shift to the zero-power mode as a result of a key of the motor vehicle being turned off, or determines the shift to the zero-power mode based on an instruction given by a user operating a switch. In the case where a condition for the shift to the zero-power mode is previously set in the controller 2 included in the master data transmission device 1a, the controller 2 may determine the shift to the zero-power mode based on the condition for the shift.

If, at the above-described step S12, the MPU 3 included in the master data transmission device 1a determines to shift to the zero-power mode, the MPU 3 notifies the controller 2 of its own device to shift to the zero-power mode, and the controller 2 shifts to the zero-power mode (step S13). Next, in order to notify the transmission/reception section 4 of its own device to shift to the zero-power mode, the controller 2 included in the master data transmission device 1a changes an operation mode signal ST from Low(0) to High(1) and outputs it to the transmission/reception section 4, and stops output of the digital data TX (step S14).

Next, the transmission/reception section 4 included in the master data transmission device 1a shifts to the zero-power mode as a result of the output of the operation mode signal ST from the controller 2 of its own device becoming High(1) and the output of the digital data TX having been stopped (step S15). Then, the transmission/reception section 4 stops output of the electric signal Mout being outputted from the transmission section 6 to the transmission line 80a (step S16).

Through the processes of the above-described steps S12 to S16, the master data transmission device 1a completes the shift to the zero-power mode. This zero-power mode eliminates the need of the operation of the controller 2 and transmission/reception section 4 included in the data transmission device 1a. Through the processes of the above-described steps S12 to S16, the controller 2 and the transmission/reception section 4 are able to reduce power consumption to the utmost by their own functions. Note that, however, after the process of the above-described step S16, the MPU 3 may perform power control on the power supply section 8 to stop supplying power to the controller 2 and the transmission/reception section 4. Moreover, if necessary, power supply to the connected-device 10a connected to the data transmission device 1a may also be stopped.

In the above-described data transmission system that shifts from the normal operation mode to the zero-power mode, the controller 2 outputs the operation mode signal ST of High(1) to the transmission/reception section 4 at step S14, and in response thereto, the transmission/reception section 4 shifts to the zero-power mode. However, the MPU 3 may directly instruct the transmission/reception section 4 to shift to the zero-power mode by use of an operation mode signal. In this case, regarding the master data transmission device 1, if the MPU 3 thereof determines to shift to the zero-power mode at the above-described step S12, the MPU 3 notifies the transmission/reception section 4 of its own device to shift to the zero-power mode by use of the operation mode signal, and then the transmission/reception section 4 shifts to the zero-power mode.

In the case where the MPU 3 directly instructs the transmission/reception section 4 to shift to the zero-power mode, power supply to the transmission/reception section 4 maybe stopped in order for the transmission/reception section 4 to shift to the zero-power mode. In this case, regarding the master data transmission device 1, if the MPU 3 thereof determines to shift to the zero-power mode at the above-described step S12, the MPU 3 stops power supply from the power supply section 8 of its own device to the transmission/reception section 4, whereby the transmission/reception section 4 shifts to the zero-power mode.

Meanwhile, the slave data transmission devices 1b to 1f each determines, in the aforementioned normal operation, the presence or absence of an input of the electric signal Min from the transmission line 80 (step S52), and, if there is an input of the electric signal Min, continues the above-described step S51. Then, if the master data transmission device 1a performs the above-described step S16, thereby stopping the output of the electric signal Mout being outputted to the transmission line 80a, the input of the electric signal Min to the slave data transmission device 1b successively connected thereto via the transmission line 80a ceases. If the input of the electric signal Min has ceased, the transmission/reception section 4 included in the slave data transmission device 1b changes the reception operation mode signal NST from High(1) to Low(0) and outputs it to the MPU 3 of its own device (step S53).

Next, in response to the output of the reception operation mode signal NST becoming Low(0), the MPU 3 included in the slave data transmission device 1b shifts to the zero-power mode (step S54). Then, the MPU 3 notifies the controller 2 of its own device to shift to the zero-power mode.

Next, the controller 2 included in the slave data transmission device 1b shifts to the zero-power mode (step S55), and, in order to notify the transmission/reception section 4 of its own device to shift to the zero-power mode, changes the operation mode signal ST from Low(0) to High(2) and outputs it to the transmission/reception section 4, then stopping the output of the digital data TX (step S56).

Next, as a result of the output of the operation mode signal ST from the controller 2 of its own device becoming High(1) and the output of the digital data TX having been stopped, the transmission/reception section 4 included in the slave data transmission device 1b shifts to the zero-power mode (step S57). Then, the transmission/reception section 4 stops the output of the electric signal Mout being outputted from the transmission section 6 to the transmission line 80b (step S58).

Through the processes of the above-described steps S52 to S58, the slave data transmission device 1b completes the shift to the zero-power mode. Similarly to the master data transmission device 1a, this zero-power mode eliminates the need of the operation of the controller 2 and transmission/reception section 4 included in the slave data transmission device 1b. Through the processes of the above-described steps S52 to S58, the controller 2 and the transmission/reception section 4 are able to reduce power consumption to the utmost by their own functions. Note that, however, after the process of the above-described step S58, the MPU 3 may perform power control on the power supply section 8, thereby stopping power supply to the controller 2 and the transmission/reception section 4. Moreover, if necessary, power supply to the connected-device 10b connected to the data transmission device 1b may also be stopped.

In the above-described data transmission system that shifts from the normal operation mode to the zero-power mode, the controller 2 outputs the operation mode signal ST of High(1) to the transmission/reception section 4 at step S56, and in response thereto, the transmission/reception section 4 shifts to the zero-power mode. However, the MPU 3 may directly instruct the transmission/reception section 4 to shift to the zero-power mode. In this case, regarding the slave data transmission device 1, if the MPU 3 of its own has shifted to the zero-power mode at the above-described step S54, the MPU 3 notifies the transmission/reception section 4 of its own device to shift to the zero-power mode, and then the transmission/reception section 4 shifts to the zero-power mode.

In the case where the MPU 3 directly instructs the transmission/reception section 4 to shift to the zero-power mode, power supply to the transmission/reception section 4 maybe stopped in order for the transmission/reception section 4 to shift to the zero-power mode. In this case, regarding the slave data transmission device 1, if the MPU 3 of its own has shifted to the zero-power mode at the above-described step S54, the MPU 3 stops power supply from the power supply section 8 of its own device to the transmission/reception section 4, whereby the transmission/reception section 4 shifts to the zero-power mode.

The operation for shifting to the zero-power mode applied to the data transmission device 1b also applies to the other slave data transmission devices 1c to 1f. That is, as a result of the input of the electric signal Min inputted from the transmission line 80b having been stopped, the data transmission device 1c shifts to the zero-power mode; as a result of the input of the electric signal Min inputted from the transmission line 80c having been stopped, the data transmission device 1d shifts to the zero-power mode; as a result of the input of the electric signal Min inputted from the transmission line 80c having been stopped, the data transmission device 1e shifts to the zero-power mode; and, as a result of the input of the electric signal Min inputted from the transmission line 80e having been stopped, the data transmission device 1f shifts to the zero-power mode. The combination of these operations causes all data transmission devices 1a to 1f connected to the data transmission system to shift to the zero-power mode.

Next, with reference to FIG. 4, the operation of the data transmission system for returning from the zero-power mode to the normal operation mode is described. The return operation of the data transmission device described below is also applicable to any system in-which a plurality of data transmission devices 1 are connected so as to form a ring structure. However, for making a specific explanation, the description is made with reference to an exemplary case where six data transmission devices 1a to 1f are connected via transmission lines 80a to 80f so as to form a ring structure (see FIG. 1). Note that, as described above, when the data transmission system returns, the data transmission device 1a is the master which transmits data with the clock of its own, and the other data transmission devices 1b to 1f are slaves which operate synchronized with the clock generated at the master.

In FIG. 4, all data transmission devices 1a to 1f connected to the data transmission system are all operating in the zero-power mode (steps S21 and S61). Then, during the aforementioned zero-power mode, the master data transmission device 1a determines whether or not to return to the normal operation mode (step S22), and, if it does not return to the normal operation mode, continues the above-described step S21.

The determination in step S22 as to returning to the normal operation mode is typically performed based on a condition for return, which is set in the MPU 3 included in the master data transmission device 1a. For example, in the case where the data transmission system is provided inside a motor vehicle and has shifted to the zero-power mode as a result of a key of the motor vehicle being turned off, the MPU 3 may determine to return to the normal operation mode as a result of the key of the motor vehicle being turned on, or may determine to return to the normal operation mode based on an instruction given by a user operating a switch.

If the MPU 3 included in the master data transmission device 1a has determined at the above-described step S22 to return to the normal operation mode, the MPU 3 activates the controller 2 and transmission/reception section 4 of its own device (step S23). Regarding the activation at the above-described step S23, in the case where power supply to be supplied from the power supply section 8 has been stopped in order for the controller 2 and the transmission/reception section 4 to shift to the zero-power mode, the MPU 3 controls the power supply section 8 to resume power supply to the controller 2 and the transmission/reception section 4. Further, in the case where the controller 2 and the transmission/reception section 4 have limited power consumption to zero by their own functions to shift to the zero-power mode, the MPU 3 performs an activation process by instructing each of them to become activated and reset. In this activation process, the controller 2 included in the master data transmission device 1a is outputting the operation mode signal ST as Low(0) to the transmission/reception section 4 (step S24).

Next, based on the operation mode signal ST outputted as Low(0) from the controller 2 of its own device, the transmission/reception section 4 included in the master data transmission device 1a, which has been activated by the above-described step S23, shifts to the normal operation mode. Then, the transmission/reception section 4 performs an initialization operation on a physical layer, and, in the initialization operation, establishes clock synchronization with each data transmission device. Based on an output clock of a transmission PLL controlled by the clock control section 7 of its own device, the transmission/reception section 4 transmits, to the transmission line 80a, a lock signal LS for establishing clock synchronization with another data transmission device, as the electric signal Mout (step S25). This lock signal LS is, for example, a sinusoidal signal based on a clock frequency of the transmission PLL included in the master data transmission device 1a.

Meanwhile, the slave data transmission devices 1b to 1f are each operating in the zero-power mode, and the activity detection section 9 of its own device monitors the presence or absence of input of the electric signal Min from the transmission line 80 (step S62). If there is no input of the electric signal Min, the above-described step S61 continues. Then, if the master data transmission device 1a performs the above-described step S25, thereby outputting the lock signal LS as the electric signal Mout to the transmission line 80a, the input of the electric signal Min to the slave data transmission device 1b successively connected thereto via the transmission line 80a is started. If any input of the electric signal Min is detected, the activity detection section 9 included in the slave data transmission device 1b outputs to the MPU 3 of its own device an activity detection signal for indicating that detection (step S63).

If, at step S63, there is any input of the activity detection signal from the activity detection section 9 included in the slave data transmission device 1b, the MPU 3 of its own device activates the controller 2 and transmission/reception section 4 of its own device (step S64). Regarding the activation at the above-described step S64, in the case where power supply to be supplied from the power supply section 8 has been stopped in order for the controller 2 and the transmission/reception section 4 to shift to the zero-power mode, the MPU 3 controls the power supply section 8 to resume power supply to the controller 2 and the transmission/reception section 4. Further, in the case where the controller 2 and the transmission/reception section 4 have limited power consumption to zero by their own functions to shift to the zero-power mode, the MPU 3 performs an activation process by instructing each of them to become activated and reset. In this activation process, the controller 2 included in the slave data transmission device 1b outputs the operation mode signal ST as Low(0) to the transmission/reception section 4 (step S65).

Next, based on the operation mode signal ST outputted as Low(0) from the controller 2 of its own device, the transmission/reception section 4 included in the slave data transmission device 1b, which has been activated by the above-described step S64, shifts to the normal operation mode. Then, the transmission/reception section 4 reproduces a clock with the clock reproduction section of its own device (step S66), and transmits a lock signal LS to the transmission line 80b based on the clock outputted by its own reception PLL (step S67).

The operation for returning to the normal operation mode applied to the data transmission device 1b also applies to the other slave data transmission devices 1c to 1f. That is, as a result of the activity detection section 9 detecting an input of the electric signal Min inputted from the transmission line 80b, the data transmission device 1c returns to the normal operation mode; as a result of the activity detection section 9 detecting an input of the electric signal Min inputted from the transmission line 80c, the data transmission device 1d returns to the normal operation mode; as a result of the activity detection section 9 detecting an input of the electric signal Min inputted from the transmission line 80d, the data transmission device 1e returns to the normal operation mode; and, as a result of the activity detection section 9 detecting an input of the electric signal Min inputted from the transmission line 80e, the data transmission device 1f returns to the normal operation mode. That is, as a result of the combination of these return operations, the return to the zero-power mode is performed in regular order, starting with the master data transmission device 1a. Then, the transmission/reception section 4 of the data transmission device 1f reproduces a clock with the clock reproduction section of its own device, and transmits a lock signal LS to the transmission line 80f based on the clock outputted from the reception PLL.

After transmitting the lock signal LS to the data transmission device 1b at the above-described step S25, the master data transmission device 1a continues to be ready for a reception of the lock signal LS transmitted from the data transmission device 1f via the transmission line 80f (step S26). Then, if the slave data transmission device 1f performs the above-described step S67, thereby outputting the lock signal LS as the electric signal Mout to the transmission line 80f,the transmission/reception section 4 included in the master data transmission device 1a receives the lock signal LS from the transmission line 80f and reproduces the clock with the clock reproduction section of its own device. Thus, clock synchronization of the entire data transmission system is established.

Thereafter, the data transmission devices 1a to 1f transmit and receive a training signal for setting a criterion for data reception between them, thereby setting a criterion for data determination in the normal operation mode, and then start data transmission and reception (steps S27 and S68). Then, the process according to this flowchart is completed.

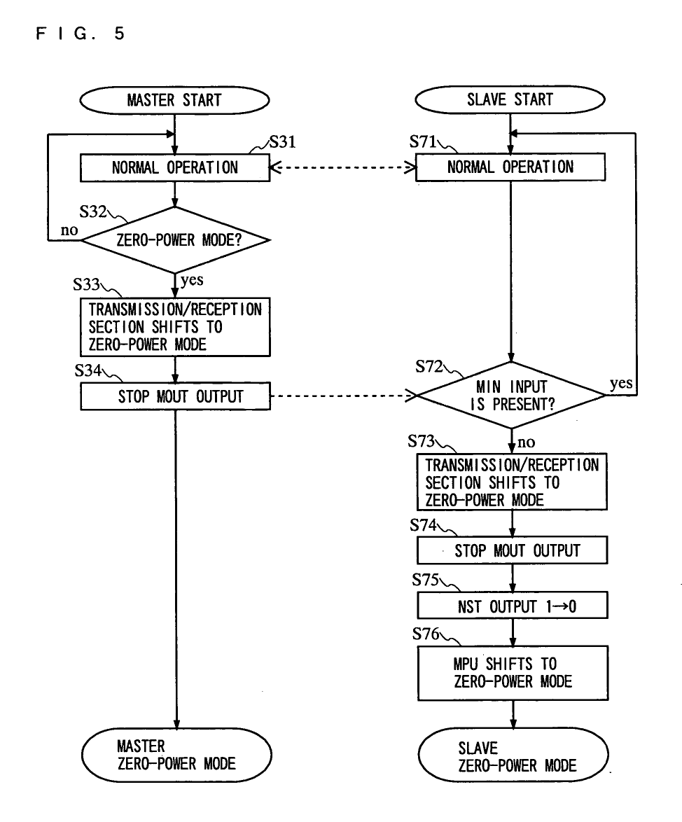

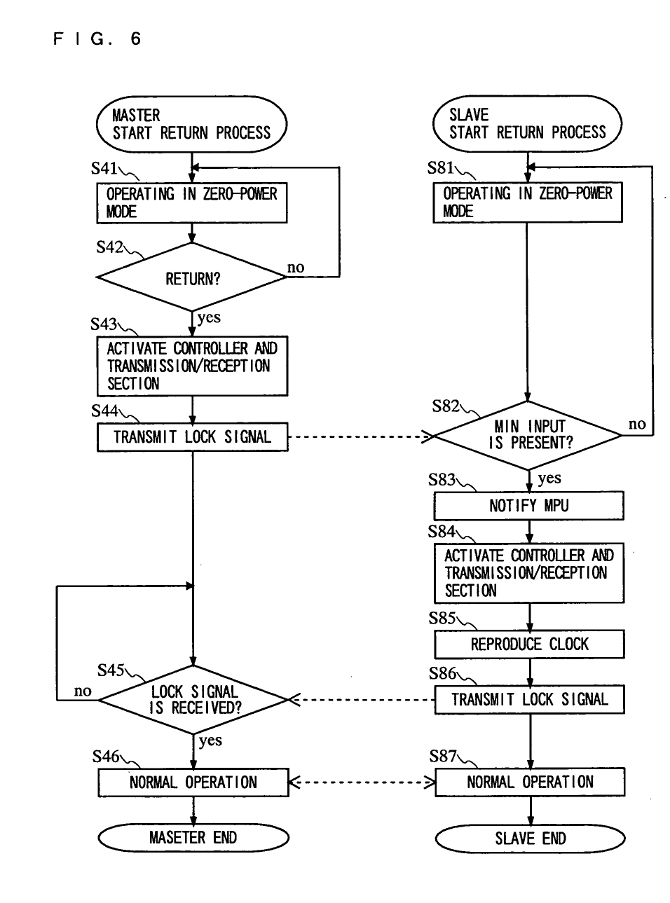

Note that in the above-described data transmission system shifting from the normal operation mode to the zero-power mode, the transmission/reception section 4 stops outputting the electric signal Mout to the successive data transmission device 1, as a result of the controller 2 making notification to the transmission/reception section 4 at step S14 or S56. Alternatively, the MPU 3 directly outputs to the transmission/reception section 4 a notification of the operation mode signal for shifting to the zero-power mode, or stops power supply to the transmission/reception section 4, so that the transmission/reception section 4 stops output of the electric signal Mout to the successive data transmission device 1. That is, in the above-described data transmission system shifting from the normal operation mode to the zero-power mode, in response to, for example, a notification by the MPU 3 or controller 2 of its own device, the transmission/reception section 4 stops output of the electric signal Mout to the successive data transmission device 1. However, the transmission/reception section 4 may stop output of the electric signal Mout to the successive data transmission device 1 without any instruction from another component. With reference to FIG. 5 and FIG. 6, the aforementioned process in which the transmission/reception section 4 stops output of the electric signal Mout to the successive data transmission device 1 is described below. Note that FIG. 5 is a flowchart showing an operation of the data transmission system for shifting from the normal operation mode to the zero-power mode, and FIG. 6 is a flowchart showing an operation of the data transmission system for returning from the zero-power mode to the normal operation mode.

First, with reference to FIG. 5, the operation of the data transmission system for shifting from the normal operation mode to the zero-power mode is described. The shifting operation of the data transmission device described below is applicable to any system in which a plurality of data transmission devices 1 are connected so as to form a ring structure. However, for making a specific explanation, the description is made with reference to an exemplary case where six data transmission devices 1a to 1f are connected via transmission lines 80a to 80f so as to form a ring structure (see FIG. 1). Note that as described above, in the data transmission system, the data transmission device 1a is the master which transmits data with the clock of its own, while the other data transmission devices 1b to 1f are slaves which operate synchronized with a clock generated at the master.

In FIG. 5, operations at steps S31, S32, and S71 of the data transmission devices 1a to 1f are identical to those of the above-described steps S11, S12, and S51; therefore, a detailed explanation thereof is omitted.

If, at the above-described step S32, the MPU 3 included in the master data transmission device 1a has determined to shift to the zero-power mode, the MPU 3 uses an operation mode signal or the like to notify the transmission/reception section 4 of its own device to shift to the zero-power mode, and the transmission/reception section 4 shifts to the zero-power mode (step S33). Then, the transmission/reception section 4 stops output of the electric signal Mout being outputted from the transmission section 6 to the transmission line 80a (step S34). Note that, at step S33, the transmission/reception section 4 may be caused to shift to the zero-power mode by the MPU 3 stopping supplying power to the transmission/reception section 4. Further, at the above-described step S33, the MPU 3 may also notify the controller 2 of its own device to shift to the zero-power mode, so that the controller 2 shifts to the zero-power mode. In this case, the controller 2 included in the master data transmission device 1a stops output of the digital data TX.

Through the processes of the above-described steps S32 to S34, the master data transmission device 1a completes the shift to the zero-power mode. This zero-power mode eliminates the need of the operation of the controller 2 and transmission/reception section 4 included in the data transmission device 1a. Through the processes of the above-described steps S32 to S34, the controller 2 and the transmission/reception section 4 are able to reduce power consumption to the utmost by their own functions. Note that, however, after the process of the above-described step S33, the MPU 3 may perform power control on the power supply section 8 to stop supplying power to the controller 2 and the transmission/reception section 4. Moreover, if necessary, power supply to the connected-device 10a connected to the data transmission device 1a may also be stopped.

Meanwhile, the slave data transmission devices 1b to 1f each determines, in the aforementioned normal operation, the presence or absence of an input of the electric signal Min from the transmission line 80 (step S72), and, if there is an input of the electric signal Min, continues the above-described step S71. Then, if the master data transmission device 1a performs the above-described step S34, thereby stopping the output of the electric signal Mout being outputted to the transmission line 80a, the input of the electric signal Min to the slave data transmission device 1b successively connected there to via the transmission line 80a ceases. By detecting that the input of the electric signal Min has ceased, the transmission/reception section 4 included in the master data transmission device 1b shifts the transmission/reception section 4 itself to the zero-power mode (step S73), and stops output of the electric signal Mout (step S74). Then, the transmission/reception section 4 in the data transmission device 1b changes the reception operation mode signal NST from High(l) to Low(0) and outputs it to the MPU 3 of its own device (step S75). Next, in response to the output of the reception operation mode signal NST being changed to Low(0), the MPU 3 of the data transmission device 1b shifts to the zero-power mode (step S76). Note that, in the process of step S76, the MPU 3 of the data transmission device 1b may notify the controller 2 of its own device to shift to the zero-power mode. In this case, the controller 2 included in the data transmission device 1b shifts to the zero-power mode and stops output of the digital data TX.

Through the processes of the above-described steps S72 to S76, the slave data transmission device 1b completes the shift to the zero-power mode. Similarly to the master data transmission device 1a, this zero-power mode eliminates the need of the operation of the controller 2 and transmission/reception section 4 included in the slave data transmission device 1b. Through the processes of the above-described steps S72 to S76, the controller 2 and the transmission/reception section 4 are able to reduce power consumption to the utmost by their own functions. Note that, however, after the process of the above-described step S76, the MPU 3 may perform power control on the power supply section 8, thereby stopping power supply to the controller 2 and the transmission/reception section 4. Moreover, if necessary, power supply to the connected-device 10b connected to the data transmission device 1b may also be stopped.

The operation for shifting to the zero-power mode applied to the data transmission device 1b also applies to the other slave data transmission devices 1c to 1f. That is, as a result of the input of the electric signal Min inputted from the transmission line 80b having been stopped, the data transmission device 1c shifts to the zero-power mode; as a result of the input of the electric signal Min inputted from the transmission line 80c having been stopped, the data transmission device 1d shifts to the zero-power mode; as a result of the input of the electric signal Min inputted from the transmission line 80c having been stopped, the data transmission device 1e shifts to the zero-power mode; and, as a result of the input of the electric signal Min inputted from the transmission line 80e having been stopped, the data transmission device 1f shifts to the zero-power mode. The combination of these operations causes all data transmission devices 1a to 1f connected to the data transmission system to shift to the zero-power mode. In contrast to the operation of steps S52 to S58 shown in FIG. 3, the operation of steps S72 to S76 allows the transmission/reception section 4 itself to stop output of the electric signal Mout; therefore, the entire data transmission system shifts to the zero-power mode quickly.

The foregoing description refers to the case where the data transmission device 1 that starts the operation for shifting the data transmission system from the normal operation mode to the zero-power mode is the data transmission device 1a which serves as the master in clock synchronization. Note that, however, any of the other data transmission devices 1b to in may start the operation for shifting to the zero-power mode. In this case, needless to say, one of the data transmission devices 1b to in which starts the operation for shifting to the zero-power mode performs the operation of the master in FIG. 5, and the remaining data transmission devices perform the operations of slaves in FIG. 5, whereby all data transmission devices 1a to 1n are able to shift to the zero-power mode in a similar manner.

Next, with reference to FIG. 6, the operation of the data transmission system for returning from the zero-power mode to the normal operation mode is described. The return operation of the data transmission device described below is also applicable to any system in which a plurality of data transmission devices 1 are connected so as to form a ring structure. However, for making a specific explanation, the description is made with reference to an exemplary case where six data transmission devices 1a to 1f are connected via transmission lines 80a to 80f so as to form a ring structure (see FIG. 1). Note that, as described above, when the data transmission system returns, the data transmission device 1a is the master which transmits data with the clock of its own, and the other data transmission devices 1b to 1f are slaves which operate synchronized with the clock generated at the master.

In FIG. 6, the operation at steps S41, S42, and S81 of the data transmission devices 1a to 1f are identical to that of the above-described steps S21, S22, and S61; therefore, a detailed description thereof is omitted.

If the MPU 3 included in the master data transmission device 1a has determined at the above-described step S42 to return to the normal operation mode, the MPU 3 activates the controller 2 and transmission/reception section 4 of its own device (step S43). Regarding the activation at the above-described step S43, in the case where power supply to be supplied from the power supply section 8 has been stopped in order for the controller 2 and the transmission/reception section 4 to shift to the zero-power mode, the MPU 3 controls the power supply section 8 to resume power supply to the controller 2 and the transmission/reception section 4. Further, in the case where the controller 2 and the transmission/reception section 4 have limited power consumption to zero by their own functions to shift to the zero-power mode, the MPU 3 performs an activation process by instructing each of them to become activated and reset.

Next, the transmission/reception section 4 included in the master data transmission device 1a, which has been activated by the above-described step S43, shifts to the normal operation mode. Then, the transmission/reception section 4 performs an initialization operation on a physical layer, and, in the initialization operation, establishes clock synchronization with each data transmission device. Based on an output clock of a transmission PLL controlled by the clock control section 7 of its own device, the transmission/reception section 4 transmits, to the transmission line 80a, a lock signal LS for establishing clock synchronization with another data transmission device, as the electric signal Mout (step S44).

Meanwhile, the slave data transmission devices 1b to 1f are each operating in the zero-power mode, and the activity detection section 9 of its own device monitors the presence or absence of input of the electric signal Min from the transmission line 80 (step S82). If there is no input of the electric signal Min, the above-described step S81 continues. Then, if the master data transmission device 1a performs the above-described step S44, thereby outputting the lock signal LS as the electric signal Mout to the transmission line 80a, the input of the electric signal Min to the slave data transmission device 1b successively connected thereto via the transmission line 80a is started. If any input of the electric signal Min is detected, the activity detection section 9 included in the slave data transmission device 1b outputs to the MPU 3 of its own device an activity detection signal for indicating that detection (step S83).

If, at step S83, there is any input of the activity detection signal from the activity detection section 9 included in the slave data transmission device 1b, the MPU 3 of its own device activates the controller 2 and transmission/reception section 4 of its own device (step S84). Regarding the activation at the above-described step S84, in the case where power supply to be supplied from the power supply section 8 has been stopped in order for the controller 2 and the transmission/reception section 4 to shift to the zero-power mode, the MPU 3 controls the power supply section 8 to resume power supply to the controller 2 and the transmission/reception section 4. Further, in the case where the controller 2 and the transmission/reception section 4 have limited power consumption to zero by their own functions to shift to the zero-power mode, the MPU 3 performs an activation process by instructing each of them to become activated and reset.

Next, the transmission/reception section 4 included in the slave data transmission device 1b, which has been activated by the above-described step S84, shifts to the normal operation mode. Then, the transmission/reception section 4 reproduces a clock with the clock reproduction section of its own device (step S85), and transmits a lock signal LS to the transmission line 80b based on the clock outputted by its own reception PLL (step S86).

The operation for returning to the normal operation mode applied to the data transmission device 1b also applies to the other slave data transmission devices 1c to 1f. That is, as a result of the activity detection section 9 detecting an input of the electric signal Min inputted from the transmission line 80b, the data transmission device 1c returns to the normal operation mode; as a result of the activity detection section 9 detecting an input of the electric signal Min inputted from the transmission line 80c, the data transmission device 1d returns to the normal operation mode; as a result of the activity detection section 9 detecting an input of the electric signal Min inputted from the transmission line 80d, the data transmission device 1e returns to the normal operation mode; and, as a result of the activity detection section 9 detecting an input of the electric signal Min inputted from the transmission line 80e, the data transmission device 1f returns to the normal operation mode. That is, as a result of the combination of these return operations, the return to the zero-power mode is performed in regular order, starting with the master data transmission device 1a. Then, the transmission/reception section 4 of the data transmission device 1f reproduces a clock with the clock reproduction section of its own device, and transmits a lock signal LS to the transmission line 80f based on the clock outputted from the reception PLL.

After transmitting the lock signal LS to the data transmission device 1b at the above-described step S44, the master data transmission device 1a continues to be ready for a reception of the lock signal LS transmitted from the data transmission device 1f via the transmission line 80f (step S45). Then, if the slave data transmission device 1f performs the above-described step S86, thereby outputting the lock signal LS as the electric signal Mout to the transmission line 80f, the transmission/reception section 4 included in the master data transmission device 1a receives the lock signal LS from the transmission line 80f and reproduces the clock with the clock reproduction section of its own device. Thus, clock synchronization of the entire data transmission system is established.

Thereafter, the data transmission devices 1a to 1f transmit and receive a training signal for setting a criterion for data reception between them, thereby setting a criterion for data determination in the normal operation mode, and then start data transmission and reception (steps S46 and S87). Then, the process according to this flowchart is completed.

As described above, the data transmission system in which a plurality of data transmission devices are connected via the transmission lines so as to form a ring structure and in which the data transmission devices electrically communicate with one another in a single direction turns off the controller and transmission/reception section included in each data transmission device in the zero-power mode, in which power of main hardware is turned off to suspend operation; therefore, power consumption is made extremely reduced in the zero-power mode. In addition, when the data transmission system returns from the zero-power mode to the normal operation mode, the master data transmission device returns to the normal operation mode upon agreement with a predetermined condition for return being obtained. In addition, the other slave data transmission devices return in combination, as a result of detecting, with the activity detection section, an electric signal transmitted from a preceding data transmission device. Therefore, for example, even in the case of a data transmission system where the MOST is used as the communications protocol to perform electrical communication, it is possible to allow the entire system to return easily.

The activity detection section 9 provided in the data transmission device 1 has been described as being disposed outside the transmission/reception section 4 independently. Note that, however, it may be disposed inside a transmission/reception section 4 composed of an LSI. In this case, if it is so arranged that only the activity detection section 9 disposed inside the LSI operates in the zero-power mode, the return to the normal operation mode is accomplished in a manner similar to that of the above-described flowcharts. In addition, the foregoing description refers to the case where the data transmission device 1 that starts the operation for returning the data transmission system from the zero-power mode to the normal operation mode is the data transmission device 1a which serves as the master in clock synchronization. However, any of the other data transmission devices 1b to 1n may start the operation for returning to the normal operation mode. In other words, even in the case where any one of the slave data transmission devices 1b to 1n first sends a lock signal LS, the activity detection section 9 of each of the other data transmission devices is able to perform activation by detecting an electric signal Min.

### INDUSTRIAL APPLICABILITY

A data transmission device, a data transmission system, and a data transmission method according to the present invention realize shifting in combination to the zero-power mode which considerably reduces power consumption of an entire device, and are usable as a device included in a system in which each device is connected via a transmission line so as to form a ring structure or the like to perform electrical communication, or as the system or the like.

1-23. (canceled)

24. A data transmission device connected to a ring-type data transmission network, which electrically communicates with another device via a transmission line in a unidirectional manner, the data transmission device comprising:
a processing section for processing received data and data to be transmitted based on a predetermined communications protocol;
a reception section for receiving an electric signal sent from a preceding device and outputting data contained in the electric signal to the processing section;
a transmission section for converting a result of a process by the processing section into an electric signal and transmitting the electric signal to a successive device;
a power supply section for supplying power to the processing section, the reception section, and the transmission section; and
a control section for controlling operation of the processing section, the reception section, and the transmission section in accordance with an operation mode of its own device, wherein,
the reception section detects cessation of the electric signal sent from the preceding device,
if the reception section detects the cessation of the electric signal, the power supply section stops supplying power to the processing section, the reception section, and the transmission section,
in response to either one of the cessation of the electric signal sent from the preceding device being detected and power supply from the power supply section being stopped, the reception section stops operating, and
in response to either one of the reception section detecting the cessation of the electric signal and the power supply from the power supply section being stopped, the transmission section stops operating and stops sending the electric signal to the successive device.

25. The data transmission device according to claim 24, wherein,
if the cessation of the electric signal sent from the preceding device is detected, the reception section transmits, to the control section, a data cessation signal for indicating the cessation, and
based on the data cessation signal transmitted from the reception section, the control section stops operation of the processing section.

26. The data transmission device according to claim 24, wherein,
if the cessation of the electric signal sent from the preceding device is detected, the reception section transmits, to the control section, a data cessation signal for indicating the cessation,
based on the data cessation signal transmitted from the reception section, the control section outputs a signal for stopping operation of the reception section and the transmission section,
in response to the signal outputted from the control section in response to the detection, the reception section stops operating, and
in response to the signal outputted from the control section in response to the detection, the transmission section stops operating and stops sending the electric signal to the successive device.

27. The data transmission device according to claim 24, wherein,
if the cessation of the electric signal sent from the preceding device is detected, the reception section transmits, to the control section, a data cessation signal for indicating the cessation, and
based on the data cessation signal transmitted from the reception section, the control section performs control of stopping the power supply section from supplying power to the processing section, the reception section, and the transmission section.

28. The data transmission device according to claim 27, further comprising a signal monitoring section for detecting the electric signal sent from the preceding device and transmitting, to the control section, an electric-signal detection signal for indicating the detection, wherein,
if suspended sending of the electric signal sent from the preceding device is resumed, the signal monitoring section detects the electric signal sent from the preceding device, and transmits, to the control section, the electric-signal detection signal for indicating the detection,
based on the electric-signal detection signal transmitted from the signal monitoring section, the control section performs control of allowing the power supply section to start supplying power to the processing section, the reception section, and the transmission section to start operation of the processing section, the reception section, and the transmission section, and
by control of the control section, the transmission section starts operating and starts sending the electric signal to the successive device.

29. The data transmission device according to claim 28, wherein the electric signal which the transmission section sends to the successive device after starting operating by control of the control section is a lock signal for establishing clock synchronization.

30. The data transmission device according to claim 24, wherein the communications protocol used by the processing section is defined by Media Oriented Systems Transport (MOST).

31. A data transmission system including a plurality of data transmission devices connected via a transmission line so as to form a ring structure, in which the data transmission devices electrically communicate with one another in a unidirectional manner,
the data transmission devices each comprising:
a processing section for processing received data and data to be transmitted based on a predetermined communications protocol;
a reception section for receiving an electric signal sent from a preceding data transmission device and outputting data contained in the electric signal to the processing section;
a transmission section for converting a result of a process by the processing section into an electric signal and transmitting the electric signal to a successive data transmission device;
a power supply section for supplying power to the processing section, the reception section, and the transmission section of its own device; and
a control section for controlling operation of the processing section, the reception section, and the transmission section in accordance with an operation mode of its own device, wherein,
in at least one of the data transmission devices, the control section stops operation of the processing section, the reception section, and the transmission section of its own device based on a predetermined condition for shift, and the transmission section stops transmission of the electric signal, and
in another data transmission device,
the reception section of its own device detects cessation of the electric signal sent from the preceding data transmission device,
if the reception section detects the cessation of the electric signal, the power supply section of its own device stops supplying power to the processing section, the reception section, and the transmission section,
in response to either one of the cessation of the electric signal sent from the preceding data transmission device being detected and power supply from the power supply section of its own device being stopped, the reception section of its own device stops operating, and
in response to either one of the reception section of its own device detecting the cessation of the electric signal and the power supply from the power supply section of its own device being stopped, the transmission section of its own device stops operating and stops sending the electric signal to the successive data transmission device.

32. The data transmission system according to claim 31, wherein, in the other data transmission device,
if the cessation of the electric signal sent from the preceding data transmission device is detected, the reception section transmits, to the control section of its own device, a data cessation signal for indicating the cessation, and
based on the data cessation signal transmitted from the reception section of its own device, the control section stops operation of the processing section of its own device.

33. The data transmission system according to claim 31, wherein,
in the other data transmission device,
if the cessation of the electric signal sent from the preceding data transmission device is detected, the reception section transmits, to the control section of its own device, a data cessation signal for indicating the cessation,
based on the data cessation signal transmitted from the reception section of its own device, the control section outputs a signal for stopping operation of the reception section and the transmission section of its own device,
in response to the signal outputted from the control section of its own device in response to the detection, the reception section stops operating, and
in response to the signal outputted from the control section of its own device in response to the detection, the transmission section stops operating and stops sending the electric signal to the successive data transmission device.

34. The data transmission system according to claim 31, wherein,
if the cessation of the electric signal sent from the preceding data transmission device is detected, the reception section transmits, to the control section of its own device, a data cessation signal for indicating the cessation, and
based on the data cessation signal transmitted from the reception section of its own device, the control section performs control of stopping the power supply section of its own device from supplying power to the processing section, the reception section, and the transmission section.

35. The data transmission system according to claim 34, wherein,
the data transmission devices each further comprise a signal monitoring section for detecting the electric signal sent from the preceding data transmission device and transmitting, to the control section, an electric-signal detection signal for indicating the detection,
in at least one of the data transmission devices, based on a predetermined return condition, the control section performs control of allowing the power supply section to start supplying power to the processing section, the reception section, and the transmission section of its own device in stopped state to start operation of the processing section, the reception section, and the transmission section, and the transmission section resumes the transmission of the electric signal, and
in another data transmission device, if suspended sending of the electric signal sent from the preceding data transmission device is resumed, the signal monitoring section detects the electric signal sent from the preceding data transmission device, and transmits, to the control section of its own device, the electric-signal detection signal for indicating the detection; based on the electric-signal detection signal transmitted from the signal monitoring section, the control section performs control of allowing the power supply section to start supplying power to the processing section, the reception section, and the transmission section of its own device to start operation of the processing section, the reception section, and the transmission section; and the transmission section starts operating and starts sending the electric signal to the successive data transmission device.

36. The data transmission system according to claim 35, wherein the electric signal which each transmission section sends to the successive data transmission device after starting operating by control of the control section is a lock signal for establishing clock synchronization with each other.

37. The data transmission system according to claim 36, wherein the data transmission device which resumes the transmission of the electric signal based on the predetermined return condition is a master, which performs data transmission with a clock held thereby and is connected to the data transmission system.

38. The data transmission system according to claim 31, wherein the communications protocol used by the processing section is defined by Media Oriented Systems Transport (MOST).

39. A data transmission method in which a plurality of nodes are connected via a transmission line so as to form a ring structure and each node electrically communicates with one another in a unidirectional manner, the method comprising:
a processing step, performed by each node, of processing received data and data to be transmitted based on a predetermined communications protocol;
a reception step, performed by each node, of receiving an electric signal sent from a preceding node and sending data contained in the electric signal to the processing step;
a transmission step, performed by each node, of transmitting a result of a process by the processing step to a successive node as an electric signal;
a power supply step of supplying power used for operation in the processing step, the reception step, and the transmission step; and
a control step, performed by each node, of controlling operation of the processing step, the reception step, and the transmission step in accordance with an operation mode, wherein,
in at least one of the nodes, the control step stops operation by the processing step, the reception step, and the transmission step of the node based on a predetermined condition for shift, and the transmission step stops transmission of the electric signal, and
in another node,
the reception step of its own node detects cessation of the electric signal sent from the preceding node,
if the reception step of its own node detects the cessation of the electric signal, the power supply step of its own node stops supplying power used for operation of the processing step, the reception step, and the transmission step of its own node,
in response to either one of the cessation of the electric signal sent from the preceding node being detected and the power supply by the power supply step of its own node being stopped, the reception step of its own node stops operation, and
in response to either one of the reception step of its own node detecting the cessation of the electric signal and the power supply step of its own node stopping supplying power, the transmission step of its own node stops operation and stops sending the electric signal to the successive node.

40. The data transmission method according to claim 39, wherein, in the other node,
if the cessation of the electric signal sent from the preceding node is detected, the reception step sends, to the control step of its own node, a notification indicating the cessation, and
based on the notification sent by the reception step of its own node, the control step stops operation by the processing step of its own node.

41. The data transmission method according to claim 39, wherein,
in the other node,
if the cessation of the electric signal sent from the preceding node is detected, the reception step sends, to the control step of its own node, a notification indicating the cessation,
based on the notification sent by the reception step of its own node, the control step sends a notification for stopping operation by the reception step and the transmission step of its own node,
in response to the notification sent by the control step of its own node in response to the detection, the reception step stops operation, and
in response to the notification sent by the control step of its own node in response to the detection, the transmission step stops operation and stops sending the electric signal to the successive node.

42. The data transmission method according to claim 39, wherein,
if the cessation of the electric signal sent from the preceding node is detected, the reception step sends, to the control step of its own node, a notification indicating the cessation, and
based on the notification sent by the reception step of its own node, the control step performs control of stopping the power supply step of its own node from supplying power used for operation of the processing step, the reception step, and the transmission step.

43. The data transmission method according to claim 42, wherein,
the nodes each further comprise a signal monitoring step of detecting the electric signal sent from the preceding node and sending, to the control step, a notification indicating the detection,
in at least one of the nodes, based on a predetermined return condition, the control step performs control of allowing the power supply step to start supplying power used for operation of the processing step, the reception step, and the transmission step of its own node in stopped state to start operation by the processing step, the reception step, and the transmission step, and the transmission step resumes the transmission of the electric signal, and
in another node, if suspended sending of the electric signal sent from the preceding node is resumed, the signal monitoring step detects the electric signal sent from the preceding node, and sends, to the control step of its own node, the notification indicating the detection; based on the notification indicating the detection sent by the signal monitoring step, the control step performs control of allowing the power supply step to start supplying power used for operation of the processing step, the reception step, and the transmission step of its own node to start operation by the processing step, the reception step, and the transmission step; and operation by the transmission step is started to start the sending of the electric signal to the successive node.

44. The data transmission method according to claim 43, wherein the electric signal which each transmission step sends to the successive node after starting operation by control of the control step is a lock signal for establishing clock synchronization with each other.

45. The data transmission method according to claim 44, wherein the node which resumes the transmission of the electric signal based on the predetermined return condition is a master, which performs data transmission with a clock held thereby.

46. The data transmission method according to claim 39, wherein the communications protocol used by the processing step is defined by Media Oriented Systems Transport (MOST).
